(19) United States
(12) Patent Application Publication
(10) Pub. No.: US 2025/0327620 A1
(43) Pub. Date: Oct. 23, 2025

(54) FURNACE FOR THE TEMPERATURE TREATMENT OF GOODS, USE OF THE FURNACE, AND METHOD FOR THE TEMPERATURE TREATMENT OF GOODS

(71) Applicant: Riedhammer GmbH, Nurnberg (DE)

(72) Inventors: Rainer Gundel, Erlangen (DE); Andreas Overhoff, Langensendelbach (DE); Matthias Uhl, Sugenheim/Ullstadt (DE)

(73) Assignee: Riedhammer GmbH, Nurnberg (DE)

(21) Appl. No.: 18/965,694

(22) Filed: Dec. 2, 2024

(30) Foreign Application Priority Data
Dec. 4, 2023 (EP) 23214047.5

(51) Int. Cl. F27B 9/12; F27B 9/04; F27B 9/24

(52) U.S. Cl. CPC F27B 9/12; F27B 9/045; F27B 9/2407; F27B 2009/126

(57) ABSTRACT

The invention relates to a furnace for the temperature treatment of goods, use of the furnace and a method for the temperature treatment of goods.

The invention relates to a furnace for the temperature treatment of goods, use of the furnace and a method for the temperature treatment of goods.

Furnaces for the temperature treatment of goods are to subject goods to temperature, in order to change their properties in the process. In particular, such furnaces are known as industrial furnaces. Such furnaces typically comprise a furnace chamber, where the goods may be received and where said goods may be subjected to temperature. For subjecting the goods to temperature, furnaces comprise heating means, by means of which the furnace chamber may be subjected to temperature, such that the temperature within the furnace chamber is transferred onto the goods and said goods may be subjected to temperature. These heating means are known, for example, in the form of electric heating means or in the form of gas burners. Furthermore, it is known to provide furnaces with transport means, by means of which goods may be transported through the furnace chamber.

One challenge is the temperature treatment of delicate goods in furnaces. For instance, these delicate goods may only be subjected to temperature very gently, and they must also be uniformly exposed to a specific furnace atmosphere during their temperature treatment within the furnace. For example, during their temperature treatment, certain delicate goods may only be exposed to a furnace atmosphere in the form of an inert gas atmosphere, an oxidizing atmosphere, or a reducing atmosphere.

A particular problem is the temperature treatment of delicate goods within a furnace, because these goods are to be subjected to temperature very gently, while at the same time exposing them to a specific furnace atmosphere.

This is generally not possible with the furnaces available on the market.

The invention is based on the object of providing a furnace for the temperature treatment of goods, by means of which goods may be temperature-treated gently in a specific furnace atmosphere. Furthermore, the invention is based on the object of providing a method, by means of which goods may be temperature-treated gently in a specific furnace atmosphere.

To achieve the aforementioned object, the invention provides a furnace for the temperature treatment of goods, comprising the following features:
a furnace chamber configured to receive goods;
heating means, by means of which the goods within the furnace chamber may be subjected to temperature;
transport means, by means of which the goods within the furnace chamber may be transported in a transport direction;
cooling gas conveying means, by means of which gas for cooling the goods may be conveyed through the furnace chamber in the counterflow direction to the transport direction; whereby
the furnace is configured such that a specific furnace atmosphere may be set within the furnace chamber.

To achieve the aforementioned object, a method for the temperature treatment of goods is provided, comprising the following steps:
providing a furnace according to the invention;
providing goods;
transporting goods within the furnace chamber by means of the transport means in a transport direction;
subjecting the goods within the furnace chamber to temperature by means of the heating means;
conveying gas for cooling the goods through the furnace chamber by means of the cooling gas conveying means in the counterflow direction to the transport direction, such that the goods are cooled by means of the gas;
setting a specific furnace atmosphere.

One basic idea of the invention is to convey cooling gas, that is, gas, by means of which the goods transported through the furnace may be cooled, in the counterflow direction to the transport direction of the goods through the furnace chamber, while a specific furnace atmosphere is set at the same time. The furnace according to the invention is therefore configured such that the basic idea may be realized by the furnace according to the invention. In particular, the furnace is configured such that the goods, while they may be transported in the transport direction by means of the transport means, may be cooled by the gas for cooling the goods, which may be conveyed in the counterflow direction to the transport direction through the furnace chamber. In particular, the furnace is further configured such that a specific furnace atmosphere may be set within the furnace chamber.

By cooling the goods during their transport through the furnace chamber by means of gas for cooling the goods (hereinafter also referred as “cooling gas”), the goods may be particularly gently subjected to temperature during their temperature treatment by means of the heating means in the furnace chamber. In particular, the temperature application to the goods or their cooling by means of the cooling gas may be controlled in a directed manner, for example via the temperature, the flow rate, or the volumetric flow of the cooling gas directed through the furnace chamber. Because the furnace is configured such that a specific furnace atmosphere may be set within the furnace chamber, a desired furnace atmosphere can be set in the furnace chamber that may be adjusted to the optimum furnace atmosphere during the temperature treatment of the goods.

Therefore, by means of the furnace and the method according to the invention, in particular delicate goods may be subjected particularly advantageously to temperature.

In accordance with the invention it has been found that the goods may be subjected to temperature in the furnace according to the invention particularly gently, if they are also subjected to the cooling gas during the entire application of temperature. A preferred embodiment may provide that the goods, while they are subjected to temperature within the furnace chamber by means of the heating means, may be cooled by means of the cooling gas. Correspondingly, the invention may provide that the furnace is configured such that the goods may be cooled by means of the cooling gas while they are subjected to temperature within the furnace chamber by means of the heating means.

An embodiment may provide that the cooling gas conveying means comprise cooling gas supply means, via which the gas for cooling the goods may be supplied to the furnace chamber. These cooling gas supply means may be designed in accordance with the means known in the art for supplying gas to a furnace chamber. In this respect, the cooling gas supply means may, for example, comprise at least one opening, through which the cooling gas may be supplied to the furnace chamber. This at least one opening may, for instance, be configured as a nozzle. The cooling gas supply means may be configured such that cooling gas may be injected into the furnace chamber at one or more points. For example, if the cooling gas supply means comprise a plurality of openings, cooling gas may be supplied to the furnace chamber through a plurality of openings at a plurality of points. Particularly preferably, it may be provided that the cooling gas supply means are configured such that cooling gas may be supplied to the furnace chamber at a plurality of points along the transport direction. Thereby, the goods may be cooled particularly gently along their transport path with cooling gas in counterflow.

According to an embodiment, it may be provided that the cooling gas conveying means comprise gas discharge means, via which gas may be discharged from the furnace chamber. The gas that may be discharged or extracted via the gas discharge means may in particular be combustion gas produced during the temperature treatment of the goods in the furnace. These gas discharge means may be designed in accordance with the means known in the art for discharging or extracting gas or combustion gas, respectively, from a furnace chamber. In this respect, the gas discharge means may, for example, comprise at least one opening, through which the gas may be discharged from the furnace chamber. The gas discharge means may be configured such that gas may be discharged from the furnace chamber at one or more points. For example, if the gas discharge means comprise a plurality of openings, gas may be discharged from the furnace chamber through a plurality of openings at a plurality of points. Particularly preferably, it may be provided that the gas discharge means are configured such that cooling gas may be discharged from the furnace chamber at a plurality of points along the transport direction. This allows gas or combustion gas, respectively, to be extracted particularly gently and uniformly from the furnace chamber along the transport path of the goods, which results in an additionally particularly gentle treatment of the goods in the furnace.

A particularly preferred embodiment may provide that the furnace according to the invention is configured and that the method according to the invention is performed such that gas circulation or a routing of gas in a cycle takes place for cooling the goods in the furnace by means of the cooling gas. Thereby, preferably cooling gas, in particular via the cooling gas supply means, is fed into the furnace chamber, then conveyed through the furnace chamber in counterflow, subsequently, in particular via the gas discharge means, the gas produced in the furnace chamber is again extracted from the furnace chamber, this gas is then cooled and finally conveyed once more to the cooling gas supply means, where the cooled gas is once more fed in to the furnace chamber as cooling gas. This is a particularly simple and effective way to cool the goods in the furnace in counterflow, while at the same time controlling the furnace atmosphere. This is because by routing the gas in a cycle, ingress of false air, which could change or otherwise impact the furnace atmosphere, may simply be avoided.

According to a preferred embodiment, the cooling gas conveying means may comprise gas conveying means, by means of which gas that may be discharged from the furnace chamber via the gas discharge means may be conveyed to the cooling gas supply means. These gas conveying means may be designed in accordance with the means known in the art for conveying gas, in particular combustion gas. In this respect, the gas conveying means may specifically comprise at least one gas line and at least one blower. By means of such a gas conveying means, gas extracted from the furnace chamber may be conveyed back to the cooling gas supply means in a particularly simple fashion.

According to a preferred embodiment, gas may be evacuated via the gas discharge means from the furnace chamber by means of the gas conveying means. The discharge of gas from the furnace chamber occurs therefore not only passively, rather, the gas is selectively evacuated from the furnace chamber, in particular by means of underpressure. Such an extraction or evacuation of gas from the furnace chamber may be achieved particularly easily and effectively, if the gas conveying means, as described above, comprise a blower that may produce underpressure at the gas discharge means, via which underpressure gas may be evacuated from the furnace chamber.

According to a preferred embodiment, gas for cooling the goods may be injected into the furnace chamber via the cooling gas supply means by means of the gas conveying means. The supply of cooling gas to the furnace chamber occurs therefore not only passively, rather, the cooling gas is selectively forced or injected, respectively, into the furnace chamber, in particular by means of excess pressure. Such an injection of cooling gas into the furnace chamber may be achieved particularly easily and effectively, if the gas conveying means, as described above, comprise a blower that may produce excess pressure at the cooling gas supply means, via which cooling gas may be injected into the furnace chamber.

A preferred embodiment provides that the furnace according to the invention is configured such that the cooling gas conveying means comprise a cooling device by means of which gas may be cooled. The cooling device serves to produce the cooling gas that cools the goods. As explained above, it may preferably be provided that gas that may be discharged from the furnace chamber via the gas discharge means may be cooled by means of the cooling device, such that the gas circulation described above may be realized.

A preferred embodiment provides that the gas conveying means comprise the cooling device. This way, the gas circulation described above may be realized in a particularly simple and effective manner, because the gas conveying means not only allow evacuating gas from the furnace chamber and conveying it to the cooling gas supply means, but also cooling the gas during said conveyance and thereby supplying it once more as cooling gas to the furnace chamber.

As a matter of principle, the cooling device may be provided in the form of any means known in the art for cooling gas, in particular combustion gas. According to a particularly preferred embodiment, the cooling device comprises a heat exchanger. This allows the gas extracted from the furnace chamber to be cooled in a particularly simple and effective manner and subsequently supplied once again to the furnace chamber as cooling gas. In particular, such a heat exchanger may be provided in the form of an air or water heat exchanger. A particular advantage of using a heat exchanger for cooling the gas and for producing cooling gas, respectively, is that ingress of false air into the system may be prevented this way, such that the furnace atmosphere is not affected.

In this regard, it may preferably be provided that gas dischargeable from the furnace chamber via the gas discharge means by means of the gas conveying means may be cooled by means of the cooling device and the cooled gas may be conveyed to the cooling gas supply means.

In order to be able to set a desired furnace atmosphere in the furnace according to the invention, the furnace is configured such that a specific furnace atmosphere may be set within the furnace chamber. To this end, the furnace chamber may in particular be sealable from the environment, in particular sealable in a gas-tight manner. Here, “environment” refers to the space outside the furnace. In this respect, the furnace may comprise sealing means, for example, that allow sealing the furnace chamber off from the environment. In principle, the furnace may be sealed against the environment in accordance with technologies known in the art.

In the correspondingly sealable furnace chamber, a definable or desired furnace atmosphere may be set, that is, for example an inert gas atmosphere, an oxidizing atmosphere, or a reducing atmosphere, depending on the optimal atmosphere for the temperature treatment of the goods in the furnace.

In order to seal the furnace chamber against the environment and thereby prevent ingress of false air from the environment into the furnace chamber, a preferred embodiment may provide that the furnace comprises at least one airlock, through which the furnace chamber may be supplied with goods.

According to the invention, it has surprisingly been found that the goods may be particularly effectively cooled by the cooling gas, if the cooling gas is conveyed in a turbulent counterflow to the transport direction through the furnace chamber. This finding contrasts the prevailing view in the prior art, that cooling gases are to be passed through a furnace preferably in laminar fashion. According to the invention, it has now been found, that a particularly good heat transfer from the goods to the cooling gas occurs, if the cooling gas flows around the goods in turbulent fashion. Therefore, a preferred embodiment provides, that the furnace is configured such that the gas for cooling the goods may be conveyed through the furnace chamber in turbulent counterflow to the transport direction, or that the gas for cooling the goods is passed through the furnace chamber in turbulent counterflow to the transport direction, in order to cool the goods.

According to the invention it was found that such a turbulent counterflow may be generated in particular, if the goods are transported through the furnace chamber by means of transport rollers. A preferred embodiment therefore provides that the transport means comprise transport rollers, by means of which the goods may be transported through the furnace chamber.

Transport rollers for industrial furnaces are known in the art, for example for roller furnaces. In this respect, the furnace according to the invention may be designed as a type of a roller furnace. As is known, a roller furnace is a continuously operated industrial furnace, which comprises transport means in the form of transport rollers, by means of which the goods are transported through the furnace chamber.

The transport rollers may, as is known in the art, be arranged parallel to each other, in particular in a plane, such that goods disposed on the transport rollers are transported along the plane by rotating the transport rollers. The transport rollers may preferably be driven, for example via a motorized chain drive, or also a plurality of individual motorized drives.

The transport rollers may, as is known in the art, configured to be rotatable about their longitudinal axis, whereby the longitudinal axis preferably extends horizontally and transversely to the transport direction. The transport rollers are preferably made of ceramic on the outside, which prevents contamination of the goods in the furnace chamber due to metal abrasion from the rollers.

Preferably, the transport rollers are spaced apart from each other. According to the invention, it has been found that cooling gas is able to flow between the transport rollers, thereby promoting a turbulent flow of the cooling gas.

A particularly preferred embodiment provides that the transport means, in particular in the form of transport rollers, are arranged such that cooling gas may be or is conveyed, respectively, through the furnace chamber above and below the transportation means, that is, in particular above and below a plane defined by transport means in form of transport rollers, in counterflow to the transport direction.

A further development of this inventive idea may provide that cooling gas may be or is supplied into the furnace chamber via the cooling gas supply means above and below the transport means.

Correspondingly, an embodiment may provide that cooling gas may be or is discharged from the furnace chamber via the gas discharge means above and below the transport means.

If cooling gas is supplied to the furnace chamber above and below the transport means, this leads in particular to the formation of turbulent counterflow of cooling gas in the furnace chamber, because gas flows between the transport rollers spaced apart from each other, which leads to turbulence of the gas in the furnace chamber. As explained above, this allows the goods to be cooled particularly effectively. This cooling effect may be amplified when the gas is again discharged from the furnace chamber above and below the transport means.

A preferred embodiment provides that the furnace chamber has the shape of a tunnel.

A preferred embodiment provides that the furnace chamber extends linearly. This makes it particularly easy to transport the goods through the furnace chamber. A preferred further development of the inventive idea may provide that the furnace chamber is tunnel-shaped and extends linearly, because this makes the transportation of the goods through the furnace chamber particularly simple.

The furnace according to the invention is preferably an industrial furnace, most preferably a continuous industrial furnace. As is well-known, in a continuous industrial furnace, goods are continuously subjected to temperature, while they are transported through the furnace chamber.

For example, as described above, the furnace according to the invention may be designed as a type of an industrial furnace in the form of a roller furnace.

A preferred embodiment may provide that the furnace chamber comprises a furnace inlet and a furnace outlet. The furnace chamber may be supplied with goods through the furnace inlet, and the goods treated in the furnace chamber may be removed again from the furnace chamber through the furnace outlet. If the furnace chamber, as described above, is tunnel-shaped and extends in particular linearly, the furnace inlet and the furnace outlet may be located at the two opposite ends of the tunnel.

According to an embodiment, the furnace inlet and the furnace outlet may each be closed by a furnace door, in particularly sealable in a gas-tight manner, such that a specific furnace atmosphere may be set within the furnace chamber. These furnace doors are preferably designed, as explained above, as airlocks, because airlocks are particularly advantageous in that they allow sealing the furnace chamber in a gas-tight manner during operation and at the same time allow the continuous infeed of goods into the furnace chamber and the removal of goods from the furnace chamber.

In principle, the heating means may be provided in the form of any heating means known in the art, by means of which the goods may be subjected to temperature in the furnace chamber. According to a preferred embodiment, the heating means comprise electric heating means, for example electric resistance-heating elements. By subjecting the goods to electric heating means, the goods may be particularly gently and accurately subjected to temperature.

A particularly preferred embodiment provides that cooling pipes may be arranged in the furnace chamber. The furnace chamber may be cooled through these cooling pipes, that is, by cooling according to the invention by conveying cooling gas in counterflow.

According to the invention, it was found that by using these cooling pipes, not only additional cooling of the goods, but also a particularly uniform cooling across the furnace cross section may be achieved.

Particularly preferably, cooling pipes are provided in the form of cooling pipes through which fluid can flow. Preferably, fluid in the form of water or air may be able to flow through these cooling pipes, in order to effectuate additional cooling of the furnace chamber. In particular, it may be provided that the cooling pipes are arranged in the furnace chamber above and below the transport means, in particular above and below transport means in the form of transport rollers.

According to the invention, it has been found that the furnace according to the invention and the method according to the invention are particularly suitable for the temperature treatment of powdered goods. According to a preferred embodiment the furnace according to the invention is then provided for the temperature treatment of powdered goods.

In particular, these powdered goods may be provided in the form of powdered cathode materials (cathode active materials, CAM) or powdered anode materials (anode active materials, AAM). According to the invention, it has been found that these powdered goods may be temperature treated using the furnace and method according to the invention in a particularly advantageous manner.

A subject matter of the invention is also the use of the furnace for the temperature treatment of goods in powder form, in particular for the temperature treatment of goods in powder form in form of the aforementioned powdered cathode material and/or the powdered anode material in powder form.

Further features of the invention will be apparent from the claims, the drawing, and the accompanying description of the drawing.

All features of the invention may be combined with each other, individually or in combination, as desired.

An exemplary embodiment of the invention will be explained in more detail with reference to the drawing and the accompanying description of the drawing in a very schematic manner.

Therein:

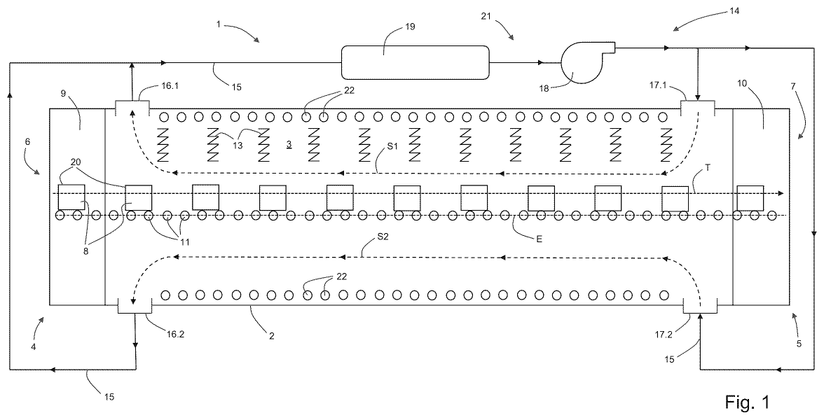

FIG. 1 very schematically illustrates a sectional side view of an exemplary embodiment of a furnace according to the invention along the transport direction.

The furnace of FIG. 1 as a whole is labeled with the reference numeral 1.

The furnace 1 includes a furnace wall 2. The furnace wall 2 includes a steel casing that is lined with refractory ceramic on the inside. The furnace wall 2 encloses a tunnel-shaped furnace chamber 3 configured to receive goods 8. The furnace chamber 3 is tunnel/shaped and linearly extends form a first (in FIG. 1 left) end 4 of the furnace chamber 3 to a second (in FIG. 1 right) end 5 of the furnace chamber 3. At its first end 4, the furnace 1 includes a furnace inlet 6, and at its second end 5 a furnace outlet 7. The furnace chamber 3 may be supplied with goods 8 through the furnace inlet 6. These goods 8 may be removed in turn from the furnace chamber 3 through the furnace outlet 7. The furnace inlet 6 may be closed by a first airlock 9, and the furnace outlet 7 may be closed by a second airlock 10. The first airlock 9 and the second airlock 10 are each configured such that the furnace chamber 3 may be closed off by means of the airlocks 9, 10 in a gas-tight manner, while at the same time allowing continuous infeed and removal of goods 8 into and out of the furnace chamber 3.

The furnace 1 is designed in the form of a continuously operating roller furnace according to a type of industrial furnace and includes transport rollers 11 as transport means, by means of which the goods 8 may be transported from the first end 4 of the furnace chamber 3 to the second end 5 of the furnace chamber 3 in a transport direction T. The transport direction T runs in the illustration of FIG. 1 from left to right in the direction of the arrow along the dashed line labeled with a T. The transport rollers 11 extend horizontally and transversely to the transport direction T, in the illustration of FIG. 1 perpendicular to the plane of the drawing. Thereby, the transport rollers 11 are spaced apart from each other in a horizontal plane E. The transport rollers 11 may be driven or rotated by a motorized chain drive (not shown).

Goods 8 disposed within the furnace chamber 3 may be subjected to temperature by means of heating means 13 arranged within the furnace chamber 3 in the form of electric resistance-heating elements. The heating means 13 are disposed along the entire furnace chamber 3.

Furthermore, the furnace 1 includes cooling gas conveying means 14, by means of which gas for cooling the goods 8 may be conveyed through the furnace chamber 3 in the counterflow direction to the transport direction T. The cooling gas conveying means 14 are configured such that cooling gas may be conveyed in the manner of gas circulation or a cycle. For this purpose, the cooling gas conveying means 14 include cooling gas supply means 17.1, 17.2, gas discharge means 16.1, 16.2, gas conveying means 21, and a cooling device 19. The cooling gas conveying means 14 are sealed against the environment in a gas-tight manner and connected to the furnace chamber 3 in terms of gas flow solely via the cooling gas supply means 17.1, 17.2 and the gas discharge means 16.1, 16.2.

The cooling gas supply means 17.1, 17.2 are arranged adjacent to the furnace outlet 7 and include an upper opening 17.1 and a lower opening 17.2, which each end in the furnace chamber 3. The upper opening 17.1 ends above plane E of the transport rollers 11, and the lower opening 17.2 ends below plane E of the transport rollers 11 in the furnace chamber 3.

The gas discharge means 16.1, 12.2 are arranged adjacent to the furnace inlet 6 and include an upper opening 16.1 and a lower opening 16.2, which each end in the furnace chamber 3. The upper opening 16.1 ends above plane E of the transport rollers 11, and the lower opening 16.2 ends below plane E of the transport rollers 11 in the furnace chamber 3.

The gas conveying means 21 include gas lines 15, a blower 18, and a cooling device 19. In terms of flow, the gas lines 15 connect the gas discharge means 16.1, 16.2 with the cooling gas supply means 17.1, 17.2, such that gas may be conveyed or flowed through the gas lines 15 from the gas discharge means 16.1, 12.2 to the cooling gas supply means 17.1, 17.2. The gas lines 15 run outside of the furnace chamber 3. In order to be able to convey gas through the gas lines 15 from the gas discharge means 16.1, 12.2 to the cooling gas supply means 17.1, 17.2, the blower 18 is connected to the gas lines 15 such that gas may actively be conveyed from the gas discharge means 16.1, 12.2 to the cooling gas supply means 17.1, 17.2 by means of the blower 18. The cooling device 19 is an air heat exchanger. The gas lines 15 are coupled with the cooling device 19, such that gas flowing through the gas lines 15 may be cooled by the cooling device 19 or the air heat exchanger, respectively.

When the blower 18 is running, cooling gas is supplied to the furnace chamber 3 via the cooling gas supply means 17.1, 17.2 due to the excess pressure created by the blower 18 in the region of the cooling gas supply means 17.1, 17.2. At the same time, the blower 18 creates underpressure in the region of the gas discharge means 16.1, 16.2, whereby gas within the furnace chamber 3, in particular combustion gas present in the furnace chamber 3 during the temperature treatment of the goods 8, is extracted via the gas discharge means 16.1, 16.2. The extracted gas is then in turn fed through the gas lines 15 to the cooling gas supply means 17.1, 17.2 by means of the blower 18 and there injected into the furnace chamber 3. Thereby, the gas is cooled by the cooling device 19 on its way through the gas lines 15.

On its way through the furnace chamber 3, the cooling gas flows against the transport direction T of the goods 8 and thus in the counterflow direction of the transport direction T through the furnace chamber 3, that is, in FIG. 1 from right to left. Thereby, the cooling gas flows along a flow path S1 above plane E and along a flow path S2 below plane E through the furnace chamber 3.

Because the transport rollers 11 are spaced apart from each other along plane E, a portion of the cooling gas also flows transversely to the first and second flow paths S1, S2 through plane E of the transport rollers 11.

In the exemplary embodiment, the goods 8 treatable with temperature in the furnace 1 are powdered cathode material. This powdered cathode material is arranged in ceramic capsules 20, so-called saggers, whereby these ceramic capsules 20 are transported on the transport rollers 11.

Further, cooling pipes 22, through which air may flow, are arranged within the furnace chamber 3 above and below plane E along the entire furnace chamber 3.

In practice, a method according to the invention may be implemented with the furnace 1 according to the exemplary embodiment as follows.

Goods 8 are continuously fed into the furnace chamber 3 through the first airlock 9, there, they are transported by the transport rollers 11 in transport direction T, and carried out of the furnace chamber 3 through the second airlock 10. During the transport within the furnace chamber 3, the goods 8 are subjected to temperature by means of the heating means 13. Furthermore, at the same time, as explained above, cooling gas is conveyed continuously along the first and second flow paths S1, S2 in in the counterflow direction to the transport direction T through the furnace chamber 3, whereby the goods 8 are cooled. Transverse flows of cooling gas through plane E cause turbulence in the cooling gas, which leads to a turbulent counterflow, whereby the goods 8 are cooled particularly effectively. This cooling is amplified by the cooling by means of the cooling pipes 22, through which cooling air flows continuously.

The furnace 1 is sealed against the environment in a gas-tight manner. By feeding goods 8 into the furnace chamber 3 and removing goods 8 from the furnace chamber 3 through the airlocks 9, 10, and due to the air-tight seal of the cooling gas conveying means 14 against the environment, the ingress of leak air from the environment into the furnace 1 and the furnace chamber 3, respectively, may be prevented. This allows an individually specifiable furnace atmosphere to be set within the furnace 1.

Therefore, a furnace atmosphere that is optimally adapted to the treatment of the goods 8 is set during said treatment of the goods 8 in the furnace chamber 3.

1. A furnace for the temperature treatment of goods, comprising:
a furnace chamber configured to receive goods;
heating means configured to subject the goods within the furnace chamber (3) to temperature;
transport means configured to transport the goods within the furnace chamber in a transport direction; and
cooling gas conveying means configured to cool the goods by conveying gas for cooling the goods through the furnace chamber in the counterflow direction to the transport direction;
wherein
a specific furnace atmosphere is set within the furnace chamber.

2. The furnace according to claim 1, wherein the cooling gas conveying means comprise cooling gas supply means configured to supply the gas for cooling the goods to the furnace chamber.

3. The furnace according to claim 1, wherein the cooling gas conveying means comprise gas discharge means configured to discharge the conveyed gas from the furnace chamber.

4. The furnace according to claim 2, wherein the cooling gas conveying means comprise:
gas discharge means configured to discharge the conveyed gas from the furnace chamber, and gas conveying means configured to convey the discharged gas to the cooling gas supply means.

5. The furnace according to claim 4, wherein the gas conveying means is further configured to evacuate the conveyed gas from the furnace chamber via the gas discharge means.

6. The furnace furnace according to claim 4, wherein the gas conveying means is further configured to inject gas for cooling the goods into the furnace chamber via the cooling gas supply means.

7. The furnace according to claim 3, wherein the cooling gas conveying means comprise a cooling device configured to cool the discharged gas.

8. The furnace according to claim 7, wherein the cooling device comprises a heat exchanger.

9. (canceled)

10. The furnace according to claim 4, wherein the gas conveying means comprises a cooling device configured to cool the discharged gas.

11. The furnace according to claim 10, wherein the cooling device comprises a heat exchanger.

12. The furnace according to claim 9, wherein the cooled gas is conveyed to the cooling gas supply means by the gas conveying means.

13. The furnace according to claim 1, wherein the goods are powdered goods.

14. The furnace according to claim 1, wherein the transport means comprise transport rollers.

15. (canceled)

16. A method for the temperature treatment of goods, comprising:
providing a furnace, the furnace including a furnace chamber, heating means, transport means, and cooling gas conveying means, the furnace chamber being configured to receive goods, the heating means being configured to subject the goods within the furnace to temperature, the transport means being configured to transport the goods within the furnace chamber in a transport direction, the cooling gas conveying means being configured to cool the goods by conveying gas for cooling the goods through the furnace chamber in a counterflow direction to the transport direction;
providing the goods;
transporting, using the transport means, the goods within the furnace chamber in the transport direction;
subjection, using the heat means, the goods within the furnace chamber to the temperature;
E. using the cooling gas conveying means to convey the gas for cooling the goods through the furnace chamber in the counterflow direction to the transport direction to cool the goods; and
setting a specific furnace atmosphere within the furnace chamber.
